(19) United States
(12) Patent Application Publication
(10) Pub. No.: US 2011/0010122 A1
(43) Pub. Date: Jan. 13, 2011

(54) CALIBRATING SEPARATELY LOCATED CAMERAS WITH A DOUBLE SIDED VISIBLE CALIBRATION TARGET FOR IC DEVICE TESTING HANDLERS

(75) Inventor: Kexiang Ken DING, San Diego, CA (US)

Correspondence Address: FOLEY AND LARDNER LLP;SUITE 500, 3000 K STREET NW, WASHINGTON, DC, 20007, US

(73) Assignee: Delta Design, Inc.

(21) Appl. No.: 12/498,995

(22) Filed: Jul. 7, 2009

(51) Int. Cl. G06F 19/00; G01B 11/14

(52) U.S. Cl. 702/95; 356/614

(57) ABSTRACT

A camera coordinate calibration system and method are provided. The system includes a calibration contactor having at least two fiducials. The system also includes a double sided visible calibration target. A pick and place handler is provided with a device holder having at least two fiducials, where the device holder is configured to pickup the double sided visible calibration target and place the target onto the calibration contactor. The system includes a device view camera configured to image a first side of the double sided visible calibration target inserted into the device holder, and a contactor view camera configured to image a second side of the target inserted into the calibration contactor. A processor is provided that calculates a common coordinate system for the device view camera and the contactor view camera based on the images of the first and second sides of the double sided visible calibration target.

### FIELD OF THE INVENTION

The present invention relates generally to the field of integrated circuit manufacturing and testing. Specifically, the present invention is directed toward an apparatus and method for calibrating cameras for an IC device testing handler.

### BACKGROUND

Semiconductor devices are commonly tested using specialized processing equipment. The processing equipment may be used to identify defective devices and other characteristics related to the performance of such devices. Processing equipment for device testing includes pick and place machines. Pick and place machines commonly implement vision systems with cameras to automatically view, orient, transport and recognize semiconductor devices. The accuracy and efficiency of these visions systems is driven by the ability of the vision system to correctly align and place devices. Accordingly, because of the small scale of semiconductor devices, vision systems with an extremely high degree of accuracy are needed for efficient and accurate testing.

In some instances, multiple cameras are used to send information to the vision system to accurately identify, pick up, and align a semiconductor device. The cameras are calibrated by viewing each other or focusing on the same object at the same time. However, these calibration techniques are lengthy and cumbersome.

Accordingly, there is a need for a system to that efficiently establishes a single coordinate system for multiple cameras. Further, such a camera coordinate calibration system should easily integrate into existing IC device testing handlers.

### SUMMARY

According to one embodiment, a camera coordinate calibration system is provided. The system includes a calibration contactor having at least two fiducials, and a double sided visible calibration target having a first side and a second side opposing the first side. The system further includes a pick and place handler comprised of a device holder having at least two fiducials, such that the device holder is configured to pickup the double sided visible calibration target and place the double sided visible calibration target onto the calibration contactor by a locking change between the device holder and the calibration contactor. A device view camera is provided to image the first side of the double sided visible calibration target inserted into the device holder, and a contactor view camera is provided to image the second side of the double sided visible calibration target inserted into the calibration contactor. A processor calculates a common coordinate system for the device view camera and the contactor view camera based on the images of the first and second sides of the double sided visible calibration target.

According to another embodiment, a double sided visible calibration target configured to be picked up by a pick and place handler is provided. The double sided visible calibration target is comprised of a transparent material and is configured to deflect along an axis perpendicular to a calibration contactor during a locking change between the device holder and the calibration contactor.

According to yet another embodiment, a method of defining common coordinates for a multiple camera system having a calibration contactor having at least two fiducials, and a device holder having at least two fiducials is provided. The method includes the steps of picking up a double sided visible calibration target comprised of a transparent material with the device holder, imaging a first side of the double sided visible calibration target inserted into the device holder, and placing the double sided visible calibration target onto the calibration contactor by a locking change between the device holder and the calibration contactor. The method also includes the steps of imaging a second side of the double sided visible calibration target inserted into the calibration contactor, and calculating a common coordinate system based on the images of the first and second sides of the double sided visible calibration target.

It is to be understood that both the foregoing general description and the following detailed description are exemplary and explanatory only, and are not restrictive of the invention as claimed. These and other features, aspects and advantages of the present invention will become apparent from the following description, appended claims, and the accompanying exemplary embodiments shown in the drawings, which are briefly described below.

### BRIEF DESCRIPTION OF THE DRAWINGS

FIG. 1 is a diagram of a camera coordinate calibration system, according to one embodiment.

FIG. 2 is a diagram of a device holder, according to one embodiment.

FIG. 3 is a diagram of a calibration contactor, according to one embodiment.

FIG. 4 is a diagram of the deflection of a double sided visible calibration target, according to one embodiment.

FIG. 5 is a diagram illustrating a double sided visible calibration target to facilitate image stitching, according to one embodiment.

FIG. 6 is a flowchart describing a method for calibrating a testing handler given the above described system.

### DETAILED DESCRIPTION

Embodiments of the present invention will be described below with reference to the accompanying drawings. It should be understood that the following description is intended to describe exemplary embodiments of the invention, and not to limit the invention.

Applicant notes that additional pick and place handler alignment systems and methods are discussed in U.S. patent application Ser. No. 12/153,780, now U.S. Pat. No. 7,506,451, U.S. patent application Ser. No. 12/153,779, and U.S. patent application Ser. No. 12/219,106, which are incorporated herein by reference in their entirety for the pick and place handler alignment systems and methods disclosed therein.

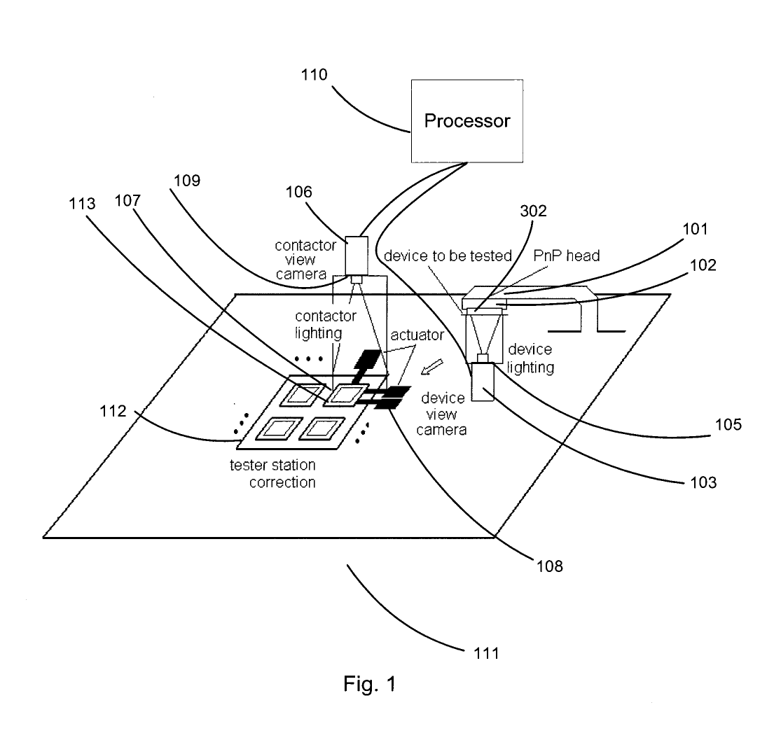

FIG. 1 is a diagram of a camera coordinate calibration system 111, according to one embodiment. The camera coordinate calibration system 111 is configured to provide a common coordinate system for the device view camera 103 and the contactor view camera 106. The system includes a pick and place handler 101. Attached to the pick and place handler 101 is a device holder 102. The pick and place handler 101 in combination with the device holder 102 is designed to pick up targets (e.g. devices, calibration targets) and place them at a testing station 112, which is comprised of contactors.

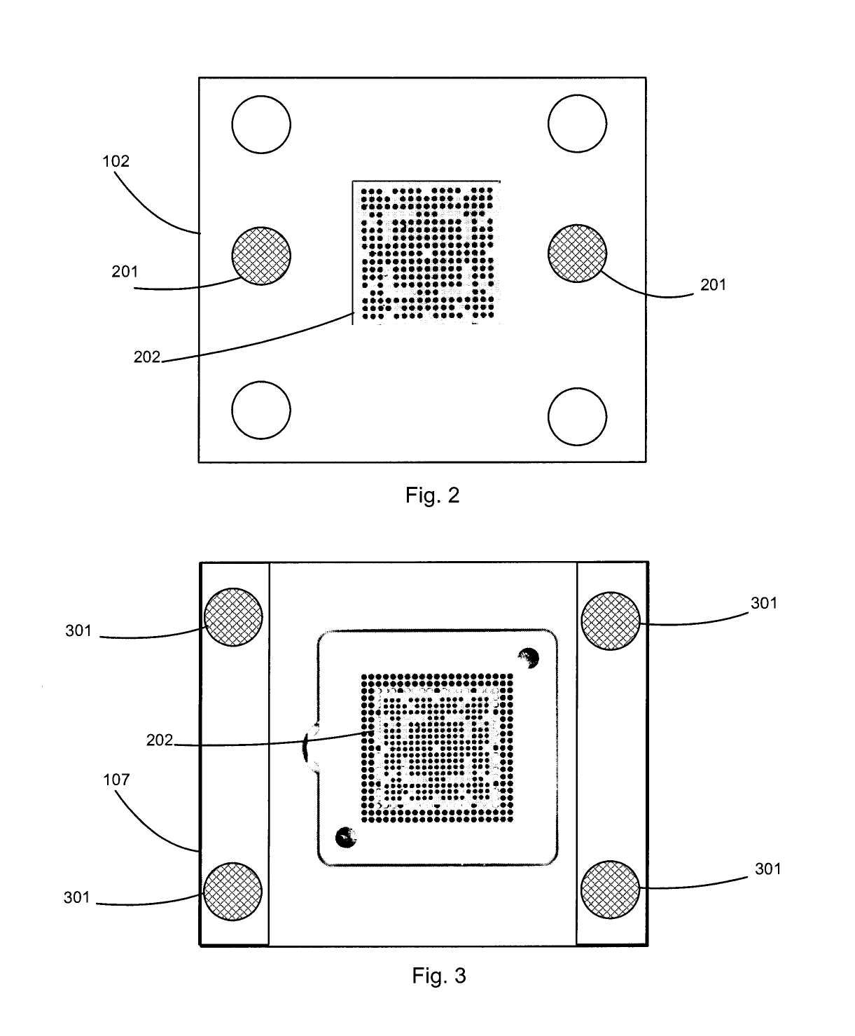

The testing station 112 is designed to test a placed target for defects and other characteristics related to the performance of such devices. In this example, the testing station 112 has a calibration contactor 107. A guiding mechanism may be provided with the calibration contactor 107, such as guiding plate 113 to which actuators 108 are attached to allow for movement of the guiding plate 113. The calibration contactor 107 is used by the camera coordinate calibration system 111 to provide the common coordinate system. In order to provide the common coordinate system, a double sided visible calibration target 202, described below in reference to FIGS. 2 and 3, is also provided. The double sided visible calibration target 202 is picked up into the device holder 102 by the pick and place handler 101. The pick and place handler 101 with the device holder 102 then places the double side visible target 202 onto the calibration contactor 107 that is located within the testing station 112 through a locking change between the calibration contactor 107 and the device holder 102. In some embodiments, the pick and place handler 101 is configured to place the double sided visible calibration target 202 onto the calibration contactor 107 with a change of position in the x or y directions of less than 10 μm during the locking change between the calibration contactor 107 and the device holder 102.

The device view camera 103 is designed to image a first side of the double sided visible calibration target 202 when the double sided visible calibration target is picked up by the pick and place handler 101 and the device holder 102. Correspondingly, the contactor view camera 106 is designed to image a second side of the double sided visible calibration target 202 once the double sided visible calibration target 202 is placed onto the calibration contactor 107. In order to allow the system to generate images with good contrast, a lighting system may be provided. In the illustrated embodiment of FIG. 1, there is a device lighting system 105 and a contactor lighting system 109. The common coordinate system is calculated from the images taken by the device view 103 and contactor view 106 cameras. The calculation is performed by a processor 110 in the system. The processor 110 receives the images and calculates the common coordinate system for the device view 103 and contactor view 106 cameras.

FIG. 2 is a diagram of a device holder 102, according to one embodiment. The device holder 102 is attached to the pick and place handler 101 and is comprised of at least two fiducials 201. In operation, the device holder 102 is configured to pickup the double sided visible calibration target 202 and place the double sided visible calibration target 202 onto the calibration contactor 107. The device view camera 103 images a first side of the double sided visible calibration target 202 inserted into the device holder 102. The double sided visible calibration target 202 is comprised of a high contrast dot array to aid calibration. The image of the first side of the double sided visible calibration target 202 as inserted into the device holder 102 is transmitted to the processor 110. The image contains at least the double sided visible target 202, as well as the two fiducials 201. The transmitted image is used, at the processor 110, in combination with an image of the second side of the double sided visible calibration target 202 to calculate a common coordinate system for the device view camera 103 and the contactor view camera 106.

FIG. 3 is a diagram of a calibration contactor 107, according to one embodiment. The calibration contactor 107 has at least two fiducials. In the illustrated embodiment of FIG. 3, the calibration contactor 107 has a total of four fiducials 301. In operation, the device holder 102 is configured to pickup the double sided visible calibration target 202 and place the double sided visible calibration target 202 onto the calibration contactor 107 through a locking change between the device holder 102 and the calibration contactor 107. The pick and place handler 101 then moves away from the device placement position. The contactor view camera 106 images a second side of the double sided visible calibration target 202 inserted into the calibration contactor 107. The image of the second side of the double sided visible calibration target 202 as inserted into the calibration contactor 107 is transmitted to the processor 110. The image contains at least the double sided visible calibration target 202, as well as the fiducials 301. The transmitted image is used, at the processor 110, in combination with an image of the first side of the double sided visible calibration target 202 to calculate a common coordinate system for the device view camera 103 and the contactor view camera 106. The calibration and establishment of a common coordinate system between the device view camera 103 and contactor view cameras 106 allows the pick and place handler 101 to move devices under test to the tester station 112 accurately by allowing adjustment by the actuators 108 to compensate for any offset of a device under test within the device holder 102.

In some embodiments, a guiding mechanism such as guiding plate 113 is provided for the calibration contactor 107. In such an embodiment, the calibration contactor 107 is stationary. Actuators 108 are attached to the guiding plate 113 which allow the guiding plate 113 to be moved in the x and y directions relative to the calibration contactor 107. In some embodiments, the actuators 108 are moved into a nominal position such that when the device holder 102 is plunged while holding the double sided visible calibration target 202, the device holder's 102 position relative to the calibration contactor 107 is not changed in the x and y directions. In other embodiments, the actuators 108 may be moved to move the guiding plate 113 such that when the device holder 102 is plunged while holding the target 202, the device holder 102 contacts the guiding plate 113 and is moved in the x or y directions or both relative to the calibration contactor 107 to facilitate more accurate center placement of the target 202 onto the calibration contactor 107 following the locking change between the device holder 102 and the calibration contactor 107.

Accordingly, the position of the guiding plate 113 may be iteratively adjusted through movement of the actuators 108 to improve the accuracy of the calculated common coordinate system through increased center placement accuracy at the calibration contactor 107. Iterative adjustment of the guiding plate 113 may be necessary if the target 202 is placed into the calibration contactor 107 with insufficient center alignment. Insufficient center alignment of the target 202 is determined by analyzing the image taken by the contactor view camera 106 by the processor 110 to determine the double sided visible calibration target's 202 position within the calibration contactor 107 relative to the fiducials 301.

Iterative adjustment of the actuators 108 and the guiding plate 113 begins by first analyzing the image taken by the contactor view camera 106 by the processor 110 to determine the double sided visible calibration target's 202 position within the calibration contactor 107 relative to the fiducials 301. If the target 202 is acceptably aligned within the calibration contactor 107, no adjustment of the actuators 108 is necessary. If the target 202 is not acceptably aligned with the calibration contactor 107, the processor 110 calculates movement adjustments to be made to the actuators 108 such that the guiding plate 113 is moved. Before the actuators 108 are moved, the pick and place handler 101 picks the target 202 back up into the device holder 102. Then, the actuators 108 are moved to move the guiding plate 113 as specified by the processor 110 calculation. The pick and place handler 101 then moves back into the device placement position and the device holder 102 contacts and moves in the x or y direction or both relative to the calibration contactor 107 based on where the guiding plate 113 was moved during movement of the actuators 108, and the double sided visible calibration target 202 is placed onto the calibration contactor 107 by a locking change. The pick and place handler 101 then moves away from the device placement position. The contactor view camera 106 once again images the double sided visible calibration contactor 202 as placed in the calibration contactor 107. The newly taken image is transmitted to the processor 110 which then analyzes the image to determine the double sided visible calibration target's 202 position within the calibration contactor 107 relative to the fiducials 301.

Here again, if the target 202 is acceptably aligned within the calibration contactor 107, no additional movement of the actuators 108 is necessary, as the device holder 102 is contacting the guiding plate 113 and moving in the x or y or both directions relative to the calibration contactor 107 sufficiently to place the target 202 with acceptable center alignment onto the calibration contractor 107. If the target 202 is not acceptably aligned, additional actuator 108 movement is calculated and the process is repeated until an acceptable alignment of the double sided visible calibration target 202 as placed onto the calibration contactor 107 is achieved. If the actuators 108 are iteratively adjusted to correct insufficient alignment of the target 202 within the calibration contactor 107, any intermediate images taken by the contactor view camera 106 of the target 202 as placed onto the calibration contactor 107 are not used in the calculation of the common coordinate system between the device 103 and contactor view 106 cameras. Rather, only the final image take by the contactor view camera 106 of the target 202 as acceptably inserted into the calibration contactor 107 is used for the calculation of the common coordinate system between the device 103 and contactor view 106 cameras.

The device holder 102 and the calibration contactor 107 may be designed to pick up and place the double sided visible calibration target 202 with more accuracy. In some embodiments, the device holder 102 has a device vacuum mechanism which applies a vacuum against the double sided visible calibration target 202 during pickup of the double sided visible calibration target 202. By applying a vacuum during pickup, the double sided visible calibration target 202 remains in approximately the same alignment within the device holder 102 during the period the double sided visible target 202 is inserted into the device holder 102. In such an embodiment, the device vacuum mechanism of the device holder 102 is configured to release the vacuum applied to the double sided visible calibration target 202 during the locking change of the double sided visible calibration target 202 with the calibration contactor 107. Additionally, in some embodiments, the calibration contactor 107 also has a contactor vacuum mechanism which applies a vacuum against the double sided visible calibration target 202 during the locking change of the double sided visible calibration target 202 with the device holder 102. The application of a vacuum by the calibration contactor 107 prevents the double sided visible calibration target 202 from shifting in the x or y plane during the locking change of the target 202 between the device holder 102 and the calibration contactor 107. The locking change between the device holder 102 and the calibration contactor 107 would occur after any adjustment of the device holder 102 relative to the calibration contactor 107 by, for example, a guiding mechanism such as guiding plate 113 as shown in FIG. 1 and discussed above.

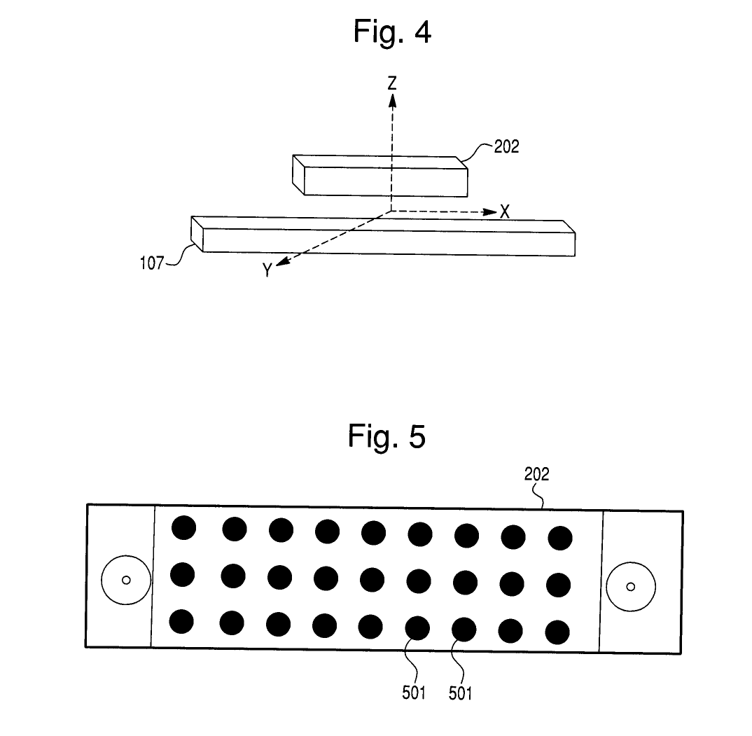

Referring now to FIG. 4, the double sided visible calibration target 202 is placed onto the calibration contactor 107 during a locking change between the device holder 102 and the calibration contactor 107 in a direction z, with little change of position perpendicular to the z direction. The double sided visible calibration target 202 is comprised of a material which deflects easily in the z direction, while not easily in any direction perpendicular to the z direction. This deflection characteristic of the double sided visible calibration target 202 facilitates a locking change of the double sided visible calibration target 202 between the device holder 102 and the calibration contactor 107 with little change of position in the x and y directions during the locking change. Additionally, this deflection characteristic ensures that the double sided visible calibration target 202 is not easily broken during placement. In some embodiments, the double sided visible calibration target 202 is comprised of a transparent material. In other embodiments, the transparent material is glass.

Referring now to the device view 103 and contactor view 106 cameras, the device view camera 103 and the contactor view camera 106 may be any one of a number of different types of digital cameras. Accordingly, either of the device view camera 103 or the contactor view camera 106 may generate a variety of different digital images. Additionally, the device view camera 103 and the contactor view camera 106 need not be the same type of camera. In some embodiments, either of the cameras may be a digital camera, which generates black and white images. In other embodiments, either of the cameras may be a digital camera which generates color images. Further, either of the cameras may be configured to generate images of varying color depth as well as varying resolution.

Further, in some embodiments, the camera coordinate calibration system 111 has a lighting system. The lighting system provides light so that the device view 103 and contactor view 106 cameras capture high contrast images. In some embodiments, a single lighting system is provided. In other embodiments, the device view camera 103 has an attached device lighting system 105. In yet other embodiments, the contactor view camera 106 has an attached contactor lighting system 109. An attached lighting system may create light angles in the range of 0 to 90 degrees incident to the object being imaged. An attached lighting system may be a three-channel programmable LED. Further, an attached lighting system can adjust the intensity of light.

Referring now to the processor 110 of the system, the processor 110 is configured to calculate a common coordinate system for the device view camera 103 and the contactor view camera 106. The processor 110 receives an image of the first side of the double sided visible calibration target 202 from the device view camera 103, and an image of the second side of the double sided visible calibration target 202 from the contactor view camera 106. With respect to the image of the first side of the double sided visible calibration target 202 supplied by the device view camera 103, the processor 110 is configured to segregate the two fiducials 201 from the double sided visible calibration target 202. Accordingly, the processor 110 is configured to determine the orientation of the double sided visible calibration target 202 relative to the fiducials 201 in the supplied image. Similarly, with respect to the image of the second side of the double sided visible calibration target 202 supplied by the contactor view camera 106, the processor 110 is configured to segregate the four fiducials 301 from the double sided visible calibration target 202. Accordingly, the processor 110 is configured to determine the orientation of the double sided visible calibration target 202 relative to the fiducials 301 in the supplied image.

Recall, from the previous discussion of FIG. 1, that the pick and place handler 101, in combination with the device holder 102 and the calibration contactor 107, is configured to place the double sided visible calibration target 202 by a locking change between the calibration contactor 107 and the device holder 102 with very little change in the x and y directions. The locking change between the device holder 102 and the calibration contactor 107 would occur after any adjustment of the device holder 102 relative to the calibration contactor 107 by, for example, a guiding mechanism such as guiding plate 113 as shown in FIG. 1 and discussed above. Because the double sided visible calibration target 202 is locking changed between the device holder 102 and the calibration contactor 107 with very little change in its x and y relative positions, the fiducials 301 of the calibration contactor 107 and the fiducials 201 of the device holder 102 may be correlated and placed into a common coordinate system through calculation by the processor 110. The calculation is based on the position of the double sided visible target 202 relative to the fiducials 201 of the device holder 102 in the first image, and the position of the double sided visible target 202 relative to the fiducials 301 of the calibration contactor 107 in the second image. That is, the alignment of the double sided visible calibration target 202 is approximately the same between the two images, allowing the position of the double sided visible target 202 relative to the two different sets of fiducials 201 and 301 to determine where those fiducials lie in a common coordinate system.

In some embodiments, a device holder 102 may be larger than the field of view of the device view camera 103. In such an embodiment, a double sided visible calibration target 202 for which an entire image can be stitched together from multiple images is provided. FIG. 5 illustrates such a double sided visible calibration target 202. The double sided visible calibration target 202 shown in FIG. 5 also includes an array of high contrast dots 501. Accordingly, the device view camera 103 is designed to image a plurality of images of the first side of the double sided visible calibration target 202. The plurality of images is then transmitted to the processor 110. In such an embodiment, the processor 110 is designed to stitch the plurality of images into a single image for use in calculating the common coordinate system for the device view camera 103 and the contactor view camera 106.

In other embodiments, a calibration contactor 107 may be larger than the field of view of the contactor view camera 106. In such an embodiment, a double sided visible calibration target 202 for which an entire image can be stitched together from multiple images is provided. FIG. 5 illustrates such a double sided visible calibration target 202. Accordingly, the contactor view camera 106 is designed to image a plurality of images of the second side of the double sided visible calibration target 202. The plurality of images is then transmitted to the processor 110. In such an embodiment, the processor 110 is designed to stitch the plurality of images into a single image for use in calculating the common coordinate system for the device view camera 103 and the contactor view camera 106.

In one embodiment, a processor 110 might include a general purpose computing device in the form of a conventional computer, including a processing unit, a system memory, a system bus that couples various system components including the system memory to the processing unit, and software to perform the calculations necessary to generate the common coordinate system. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer. In another embodiment, the processor 110 may be implemented with a special purpose computer or embedded device to calculate the common coordinate system. In other embodiments, the processor 110 may be implemented in a plurality of separate computers wherein each of the computers has separate software modules configured to calculate a portion of the common coordinate

Elements of embodiments of the processor 110 within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

Elements of the processor 110 may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Once a common coordinate system for the device view camera 103 and the contactor view camera 106 has been calculated by the processor 110, during testing runtime any offset of a device under test as held in a device holder 102 can be corrected using the actuators 108 as attached to a guiding mechanism such as a guiding plate 113 as shown in FIG. 1 and explained above. In operation, when a device under test is picked up by the device holder 102 of the pick and place handler 101, the device view camera 103 images the device under test and identifies the device's position relative to the fiducials 201 of the device holder 102. Then, using the common coordinate system established during calibration as described above and the image of the device under test showing the device's position relative to the fudicials 201, commands for the actuators 108 can be calculated using the processor 110 that cause the actuators 108 to move the guiding plate 113 into position to adjust for any offset of the device under test within the device holder 102.

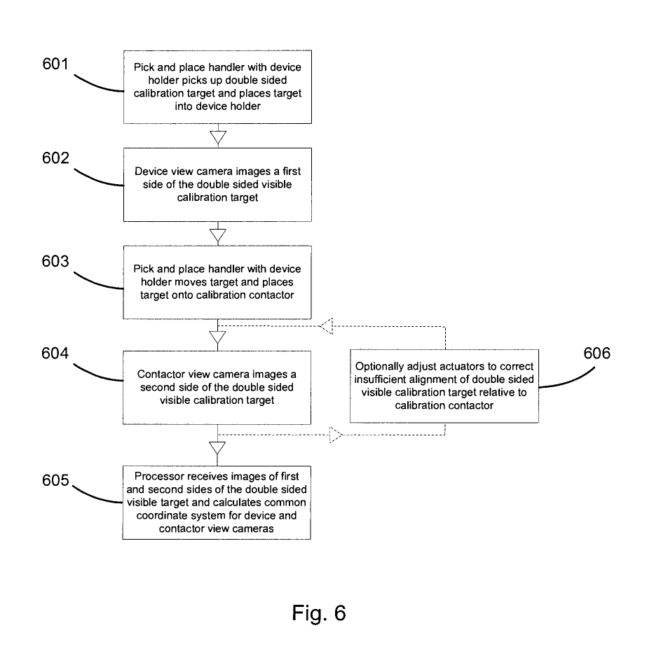

FIG. 6 is a flowchart describing a method for calibrating a testing handler given the above described system. In step 601 the pick and place handler 101 with the device holder 102 picks up the double sided visible calibration target 202 into the device holder 102. In step 602 following step 601, the device view camera 103 images a first side of the double sided visible calibration target 202. Following step 602 in step 603, the pick and place handler 101 with the device holder 102 moves the double sided visible target 202 and places the double sided visible target 202 onto the calibration contractor 107 by a locking change between the device holder 102 and the calibration contactor 107. Following step 603 in step 604, the contactor view camera 106 images a second side of the double sided visible calibration target 202. Following step 604 in step 605, the processor 110 receives images of the first and second sides of the double sided visible calibration target 202 and calculates a common coordinate system for the device view 103 and contactor view 106 cameras. Optionally, before the second side of the target 202 is imaged for the final time, actuators 108 are adjusted to correct any offset of the placement of the double sided visible calibration target 202 onto the calibration contactor 107 in step 606 before step 605

The present system provides a user friendly solution to the problem of establishing a common coordinate system among separately located cameras. Vision systems of integrated circuit testing handlers are typically comprised of multiple cameras. In many situations, these cameras cannot view one another. In those instances where the cameras cannot view one another, a common coordinate system must be substituted such that the cameras can operate together in a single known space to identify, pick up, and align semiconductor devices. The present system provides a solution to the problem of establishing a common coordinate system through the use of fiducials on a device holder and a calibration contactor, in combination with a processor and a double sided visible calibration target.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A camera coordinate calibration system, comprising:
a calibration contactor having at least two fiducials;
a double sided visible calibration target having a first side and a second side opposing the first side;
a pick and place handler comprised of a device holder having at least two fiducials, wherein the device holder is configured to pickup the double sided visible calibration target and place the double sided visible calibration target onto the calibration contactor by a locking change between the device holder and the calibration contactor;
a device view camera configured to image the first side of the double sided visible calibration target inserted into the device holder;
a contactor view camera configured to image the second side of the double sided visible calibration target inserted into the calibration contactor; and
a processor configured to calculate a common coordinate system for the device view camera and the contactor view camera based on the images of the first and second sides of the double sided visible calibration target.

2. The camera coordinate calibration system of claim 1, where the double sided visible calibration target is comprised of a transparent material and is configured to deflect along an axis perpendicular to the calibration contactor during the locking change.

3. The camera coordinate calibration system of claim 1, wherein the device view camera is provided below a pick position of the pick and place handler.

4. The camera coordinate calibration system of claim 1, wherein the contactor view camera is provided above the calibration contactor.

5. The camera coordinate calibration system of claim 1, wherein the pick and place handler is configured to place the double sided visible calibration target onto the calibration contactor with a change of position in any parallel direction to the calibration contactor of less than 10 μm during the locking change between the device holder and the calibration contactor.

6. The camera coordinate calibration system of claim 1, wherein the device holder is further comprised of a device vacuum mechanism configured to apply a vacuum against the double sided visible calibration target during pickup of the double sided visible calibration target, and configured to release the vacuum applied by the device holder to the double sided visible calibration target during the locking change of the double sided visible calibration target with the calibration contactor, and wherein the calibration contactor is further comprised of a calibration vacuum mechanism configured to apply a vacuum against the double sided visible calibration target during the locking change of the double sided visible calibration target with the device holder.

7. The camera coordinate calibration system of claim 1, further comprising:
at least three actuators connected to a guiding plate configured to correct an offset between the calibration contactor and the device holder.

8. The camera coordinate calibration system of claim 1, wherein the device view camera is configured to image a plurality of images of the first side of the double sided visible calibration target inserted into the device holder and the processor is further configured to stitch the plurality of images into a single image for use in calculating the common coordinate system.

9. The camera coordinate calibration system of claim 1, wherein the contactor view camera is configured to image a plurality of images of the second side of the double sided visible calibration target inserted into the calibration contactor and the processor is further configured to stitch the plurality of images into a single image for use in calculating the common coordinate system.

10. The camera coordinate calibration system of claim 1, further comprised of:
a lighting system.

11. The camera coordinate calibration system of claim 1, wherein the device view camera is further comprised of a device lighting system, and the contactor view camera is further comprised of a contactor lighting system.

12. The camera coordinate calibration system of claim 11, wherein the device lighting system and the contactor lighting system are comprised of three channel programmable LEDs.

13. A double sided visible calibration target configured to be picked up by a pick and place handler, wherein the double sided visible calibration target is comprised of a transparent material and is configured to deflect along an axis perpendicular to a calibration contactor during a locking change between the device holder and the calibration contactor.

14. A method of defining common coordinates for a multiple camera system having a calibration contactor having at least two fiducials, and a device holder having at least two fiducials, comprising the steps of:
picking up a double sided visible calibration target comprised of a transparent material with the device holder;
imaging a first side of the double sided visible calibration target inserted into the device holder;
placing the double sided visible calibration target onto the calibration contactor by a locking change between the device holder and the calibration contactor;
imaging a second side of the double sided visible calibration target inserted into the calibration contactor; and
calculating a common coordinate system based on the images of the first and second sides of the double sided visible calibration target.

15. The method of claim 14, wherein the double sided visible calibration target deflects along an axis perpendicular to the calibration contactor during the locking change between the device holder and the calibration contactor.

16. The method of claim 14, wherein the multiple camera system further comprises at least three actuators connected to a guiding plate, and the method further comprises the step of:
before the step of imaging a second side of the double sided visible calibration target, moving the actuators to adjust the position of the guiding plate to correct an offset between the calibration contactor and the device holder.

17. The method of claim 14, wherein the step of placing the double sided visible calibration target comprises placing the double sided visible calibration target with a change of position in any parallel direction to the calibration contactor of less than 10 μm during the locking change between the device holder and the calibration contactor.

18. The method of claim 14, wherein the step of picking up the double sided visible calibration target further comprises applying a vacuum by the device holder to the double sided visible calibration target.

19. The method of claim 18, wherein the step of placing the double sided visible calibration target onto the calibration contactor comprises releasing the vacuum applied by the device holder to the double sided visible calibration target, and applying a vacuum to the double sided visible calibration target at the calibration contactor during the locking change between the device holder and the calibration contactor.
